(19) United States
(12) Patent Application Publication
(10) Pub. No.: US 2024/0098607 A1
(43) Pub. Date: Mar. 21, 2024

(54) AUDIO PROCESSING HANDOVER BETWEEN AUDIO DEVICES

(71) Applicant: QUALCOMM Incorporated, San Diego, CA (US)

(72) Inventors: Ramji SRINIVASAN, Cambridge (GB); Chun Kun KIM, Cambridge (GB); Mehdi FALLAHPOUR, Carlsbad, CA (US); Rogerio Guedes ALVES, Macomb Township, MI (US)

(21) Appl. No.: 17/933,713

(22) Filed: Sep. 20, 2022

(51) Int. Cl. H04W 36/32; G10L 15/20; H04R 1/40; H04W 36/30

(52) U.S. Cl. CPC H04W 36/32; G10L 15/20; H04R 1/40; H04W 36/30; H04R 2420/07

(57) ABSTRACT

Disclosed are techniques for audio processing handover between audio devices. In an aspect, a method of audio processing handover between audio devices comprises selecting a first audio device to be a primary audio input device and deactivating the second audio device; performing a voice processing algorithm on the first audio device; detecting that the quality of the first audio signal does not satisfy a quality threshold, and in response, activating the second audio device and measuring the quality of the second audio signal. If the quality of the second audio signal is better than the quality of the first audio signal, select the second audio device to be the primary audio input device, deactivate the first audio device, and perform the voice processing algorithm on the second audio device. Otherwise, deactivate the second audio device for some amount of time before checking again.

### BACKGROUND OF THE DISCLOSURE

### 1. Field of the Disclosure

Aspects of the disclosure relate generally to mobile voice communication, and specifically to the operation and use of wireless earbuds and microphone with a mobile device.

### 2. Description of the Related Art

One of the ultimate goals of any earbud function in the context of mobile voice communication is to ensure the wearers voice is preserved and any unwanted external sound is suppressed as much as possible during a voice call. Conventional approaches include utilizing extra microphones such as an in-ear canal microphone or a bone-conduction microphone (BCM), both of which are bound to just one side of the earbud pair, i.e., the earbud having the additional microphone hardware. As used herein, the term “microphone set” refers to a set of one or more microphones operating in relatively close proximity to each other. For example, each earbud contains its own microphone set separate from the microphone set in the other earbud; smart glasses may have two microphone sets, one for each side of the user's head; an earbud may have a microphone set that includes an in-ear microphone and a BCM; and so on.

Moreover, voice enhancement algorithms require a non-trivial amount of processing power, and it is not power-efficient to run these processes on both earbuds. Thus, in conventional approaches, one of the two earbuds runs the voice processing algorithms on the signals received on the microphones. Whichever earbud is currently running the voice processing algorithms is referred to as the primary earbud, and the earbud not currently running the voice processing algorithms is referred to as the secondary earbud. The primary earbud can be on either side, and the role can be handed over from one earbud to the other, depending on a specified handover rule. A common handover rule is that when the RF signal strength of the primary earbud becomes too weak or when the primary earbud is taken off the ear, the processing is handed over to the secondary earbud, which then assumes the role of primary earbud.

Conventional approaches involve periodically comparing the signals from each earbud and selecting the earbud having the best signal quality. However, these approaches needlessly consume power in situations where the current primary earbud is providing a signal of sufficient quality and thus handover is not yet necessary.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of audio processing handover between audio devices includes selecting a first audio device to be a primary audio input device based on a comparison of a quality of a first audio signal from a microphone of the first audio device and a quality of a second audio signal from a microphone of a second audio device; deactivating the second audio device; performing a voice processing algorithm on the first audio device; detecting that the quality of the first audio signal does not satisfy a quality threshold, and in response: activating the second audio device; measuring the quality of the second audio signal; upon determining that the quality of the second audio signal is better than the quality of the first audio signal, selecting the second audio device to be the primary audio input device, deactivating the first audio device, and performing the voice processing algorithm on the second audio device; and upon determining that the quality of the second audio signal is not better than the quality of the first audio signal, deactivating the second audio device for a first duration of time.

In an aspect, an audio system includes a first audio device and a second audio device, each audio device comprising a microphone, a transceiver, a memory, and at least one processor coupled to the memory and the transceiver, the at least one processor configured to: select the first audio device to be a primary audio input device based on a comparison of a quality of a first audio signal from a microphone of the first audio device and a quality of a second audio signal from a microphone of the second audio device; deactivate the second audio device; perform a voice processing algorithm on the first audio device; detect that the quality of the first audio signal does not satisfy a quality threshold, and in response: activate the second audio device; measure the quality of the second audio signal; upon determining that the quality of the second audio signal is better than the quality of the first audio signal, select the second audio device to be the primary audio input device, deactivate the first audio device, and perform the voice processing algorithm on the second audio device; and upon determining that the quality of the second audio signal is not better than the quality of the first audio signal, deactivate the second audio device for a first duration of time.

In an aspect, an audio system includes means for selecting a first audio device to be a primary audio input device based on a comparison of a quality of a first audio signal from a microphone of the first audio device and a quality of a second audio signal from a microphone of a second audio device; means for deactivating the second audio device; means for performing a voice processing algorithm on the first audio device; means for detecting that the quality of the first audio signal does not satisfy a quality threshold, and in response: activating the second audio device; measuring the quality of the second audio signal; upon determining that the quality of the second audio signal is better than the quality of the first audio signal, selecting the second audio device to be the primary audio input device, deactivating the first audio device, and performing the voice processing algorithm on the second audio device; and upon determining that the quality of the second audio signal is not better than the quality of the first audio signal, deactivating the second audio device for a first duration of time.

In an aspect, a non-transitory computer-readable medium storing computer-executable instructions that, when executed by an audio system, cause the audio system to: select a first audio device to be a primary audio input device based on a comparison of a quality of a first audio signal from a microphone of the first audio device and a quality of a second audio signal from a microphone of a second audio device; deactivate the second audio device; perform a voice processing algorithm on the first audio device; detect that the quality of the first audio signal does not satisfy a quality threshold, and in response: activating the second audio device; measuring the quality of the second audio signal; upon determining that the quality of the second audio signal is better than the quality of the first audio signal, selecting the second audio device to be the primary audio input device, deactivating the first audio device, and performing the voice processing algorithm on the second audio device; and upon determining that the quality of the second audio signal is not better than the quality of the first audio signal, deactivating the second audio device for a first duration of time.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates a pair of audio devices in which a method of audio processing handover may be implemented according to aspects of the disclosure.

FIG. 2 is a flow chart illustrating a method for audio processing handover between audio devices according to aspects of the disclosure.

FIG. 3A and FIG. 3B are signaling and event diagrams illustrating portions of a process for audio processing handover between audio devices according to aspects of the disclosure.

FIG. 4A and FIG. 4B are signaling and event diagrams illustrating portions of a process for audio processing handover between audio devices according to aspects of the disclosure.

FIG. 5 is a flowchart of an example process 500 associated with audio processing handover between audio devices, according to aspects of the disclosure.

### DETAILED DESCRIPTION

Disclosed are techniques for audio processing handover between audio devices. In an aspect, a method of audio processing handover between audio devices comprises selecting a first audio device to be a primary audio input device and deactivating the second audio device; performing a voice processing algorithm on the first audio device; detecting that the quality of the first audio signal does not satisfy a quality threshold, and in response, activating the second audio device and measuring the quality of the second audio signal. If the quality of the second audio signal is better than the quality of the first audio signal, select the second audio device to be the primary audio input device, deactivate the first audio device, and perform the voice processing algorithm on the second audio device. Otherwise, deactivate the second audio device for a first duration of time.

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

One of the ultimate goals of any earbud function in the context of mobile voice communication is to ensure that the wearer's voice is preserved and that any unwanted external sound is suppressed as much as possible during a voice call. Conventional approaches involve using extra microphones such as in-ear canal microphones or bone-conduction microphones (BCMs). Since voice enhancement algorithms using these additional microphones require a non-trivial amount of power, these processes are performed on only one, not both, earbuds. The so-called primary earbud runs the processes based on the signals received on the microphones. This primary earbud can be on either side, and the role can be handed over depending on the specified handover rule for example, when the RF signal strength becomes too weak or when one earbud is taken off the ear.

In some circumstances, the external sound to be suppressed is directional, i.e., there are situations in which the noise level is higher on the microphones on one side and lower on the other side (wind noise for example). When the primary earbud is on the side with higher noise level, the voice signal-to-noise ratio (SNR) is lower than when the primary earbud is on the opposite side, assuming that the voice level is the same on both sides. Since having a high SNR on the raw microphone signal would reduce the amount of work that any voice enhancement technique would have to do, it would be beneficial to be able to detect the noise level on both sides of earbuds and switch the primary so that the best SNR is ensured in the input signals to the voice enhancement process.

Accordingly, methods and systems for audio processing handover between audio devices are herein presented. In some aspects, a first audio device is selected to be a primary audio input device based on a comparison of a quality of a first audio signal from a microphone of the first audio device and a quality of a second audio signal from a microphone of a second audio device. Subsequently, a handover decision is made based on a comparison of the quality of the audio signal from the primary audio input device and the quality of the audio signal from the secondary audio input device. In one approach, a handover decision is made based on noise levels of the audio signals from the primary and secondary audio input devices. In another approach, a handover decision is made based on SNRs of the audio signals from the primary and secondary audio input devices. In either approach, the audio device providing the better quality audio signal, e.g., lower noise, higher SNR, etc., is selected as the primary audio input device.

Example use cases include voice communication in the presence of directional noise or wind in the background, such as a user wearing true wireless stereo (TWS) earbuds with microphones or smart glasses with microphones on both sides of the user's head. In these scenarios, a directional noise source results in a noise level difference between the two ears, e.g., a difference between the noise level of a signal from a microphone on earbud and the noise level of a signal from a microphone on the other earbud, or a difference between the noise level of a signal from a microphone on one side of the smart glasses and the noise level of a signal from a microphone on the other side of the smart glasses.

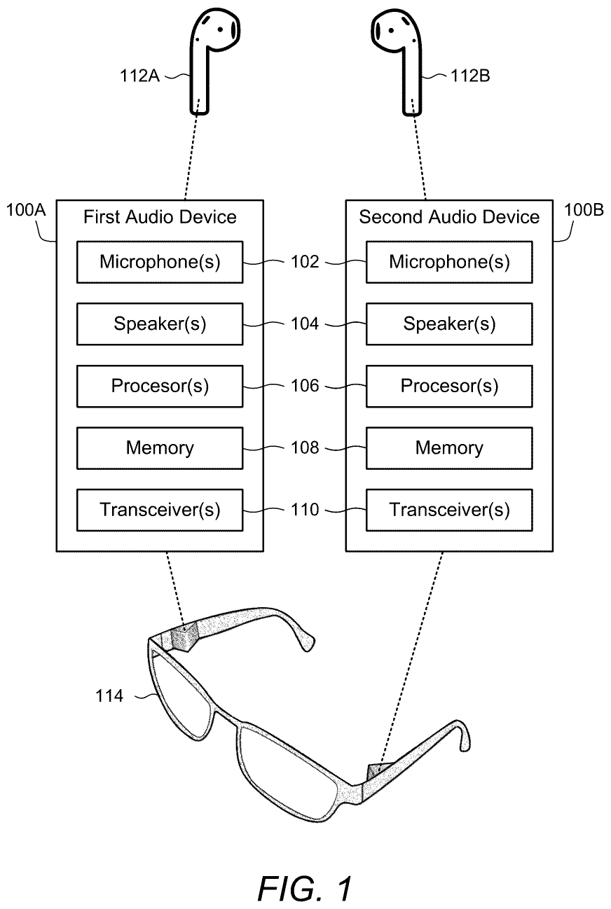

FIG. 1 illustrates a pair of audio devices in which a method of audio processing handover may be implemented according to aspects of the disclosure. In the example illustrated in FIG. 1, each of a first audio device 100A and a second audio device 100B includes one or more microphone(s) 102, one or more speaker(s) 104, one or more processor(s) 106, memory 108, and one or more transceiver(s) 110. In some aspects, the first audio device 100A may be part of a first wireless earbud 112A and the second audio device 100B may be part of a second wireless earbud 112B. In some aspects, the first and second audio devices may be components of a pair of smart glasses 114 or other user wearable device. For example, the first audio device 100A may be positioned on the right side of the user's head and the second audio device 100B may be positioned on the left side of the user's hear.

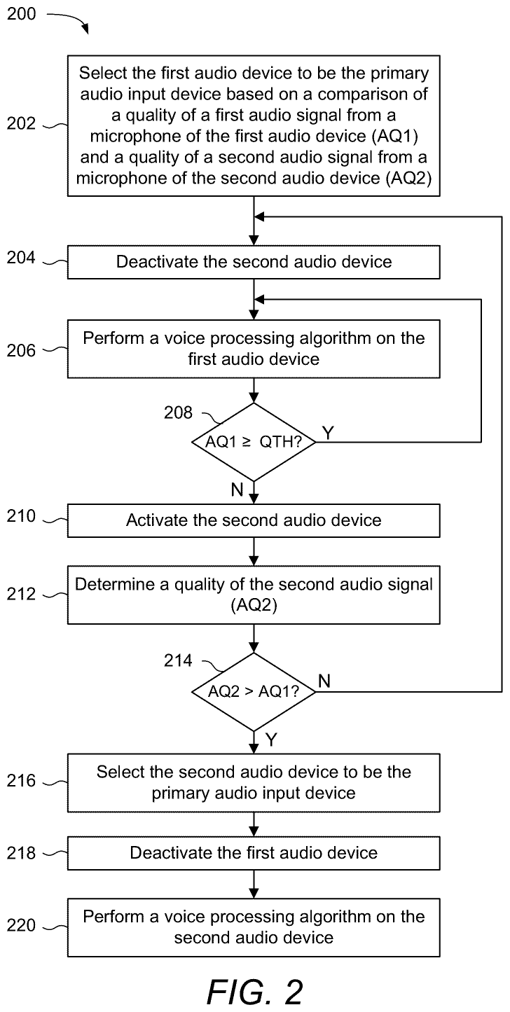

FIG. 2 is a flow chart illustrating a method 200 for audio processing handover between audio devices according to aspects of the disclosure. The method 200 may be performed by first audio device 100A and/or second audio device 100B, or by another controller that communicates with the first and second audio devices. For example, any of the steps of the method 200 may be performed by the processor(s) 106 in the first audio device 100A and in the second audio device 100B.

As shown in FIG. 2, the method 200 includes, at block 202, selecting the first audio device to be the primary audio input device based on a comparison of a quality of a first audio signal from a microphone of the first audio device (AQ1) and a quality of a second audio signal from a microphone of the second audio device (AQ2). Means for performing the operations of block 202 may include the processor(s) 106, memory 108, and/or transceiver(s) 110 of first audio device 100A and/or second audio device 100B. For example, the first audio device 100A may be selected to be the primary audio input device because the quality of the audio signal coming from its microphone(s) is better than the quality of the audio signal coming from the microphone(s) of the second audio device 100B. In some aspects, the selection may be made by one of the audio devices based on a comparison of audio from its microphone with audio picked up by the microphone of the other audio device and transmitted to the first device via the transceiver(s) 110.

As shown in FIG. 2, the method 200 further includes, at block 204, deactivating the second audio device. Means for performing the operations of block 202 may include the processor(s) 106, memory 108, and/or transceiver(s) 110 of first audio device 100A and/or second audio device 100B. For example, . . . .

As shown in FIG. 2, the method 200 further includes, at block 206, performing a voice processing algorithm on the first audio device. Means for performing the operations of block 206 may include the processor(s) 106, memory 108, and/or transceiver(s) 110 of first audio device 100A and/or second audio device 100B. For example, . . . .

As shown in FIG. 2, the method 200 further includes, at block 208, determining whether the audio quality of the first audio signal (AQ1) meets or exceeds an audio quality threshold (QTH). Means for performing the operations of block 208 may include the processor(s) 106, memory 108, and/or transceiver(s) 110 of first audio device 100A and/or second audio device 100B. For example, the first audio device 100A may determine AQ1 based on the signal received by its microphone(s) 102. If AQ1 meets or exceeds QTH, the method returns to block 206. If AQ1 fails to meet QTH, the method goes to block 210.

As shown in FIG. 2, the method 200 further includes, at block 210, activating the second audio device, and at block 212, determining a quality of a second audio signal (AQ2) from one of the microphone(s) 102 of the second audio device 100B. Means for performing the operations of block 210 and block 212 may include the processor(s) 106, memory 108, and/or transceiver(s) 110 of first audio device 100A and/or second audio device 100B. For example, the first audio device 100A may use its transceiver(s) 110 to send a message or signal to the second audio device 100B, e.g., to instruct the second audio device to start monitoring audio signals from its microphone(s) 102 and to send a value indicating the audio quality of a second audio signal (AQ2), which the first audio device 100A receives via its transceiver(s) 110.

As shown in FIG. 2, the method 200 further includes, at block 214, determining whether the audio quality at the second audio device 100B is better than the audio quality at the first audio device 100A, e.g., whether AQ1 is greater than AQ2. Means for performing the operations of block 214 may include the processor(s) 106, memory 108, and/or transceiver(s) 110 of first audio device 100A and/or second audio device 100B. For example, the processor(s) 106 may compare the values of AQ1 and AQ2 stored in memory 108. If AQ2 is not better than AQ1, then the method returns to block 204. If AQ2 is better than AQ1, then the method goes to block 216.

As shown in FIG. 2, the method 200 further includes, at block 216, selecting the second audio device to be the primary audio device. Means for performing the operations of block 216 may include the processor(s) 106, memory 108, and/or transceiver(s) 110 of first audio device 100A and/or second audio device 100B. For example, the first audio device 100A may use its transceiver(s) 110 to instruct the second audio device 100B to assume the responsibility of primary audio input device.

As shown in FIG. 2, the method 200 further includes, at block 218, deactivating the first audio device. Means for performing the operations of block 218 may include the processor(s) 106, memory 108, and/or transceiver(s) 110 of first audio device 100A and/or second audio device 100B. For example, the processor(s) 106 the first audio device 100A may configure the first audio device 100A to be the secondary audio input device, e.g., to stop performing voice processing algorithms.

As shown in FIG. 2, the method 200 further includes, at block 220, performing a voice processing algorithm on the second audio device. Means for performing the operations of block 220 may include the processor(s) 106, memory 108, and/or transceiver(s) 110 of first audio device 100A and/or second audio device 100B. For example, the second audio device 100B may perform voice processing algorithms using the processor(s) 106, memory 108, and microphone(s) 102.

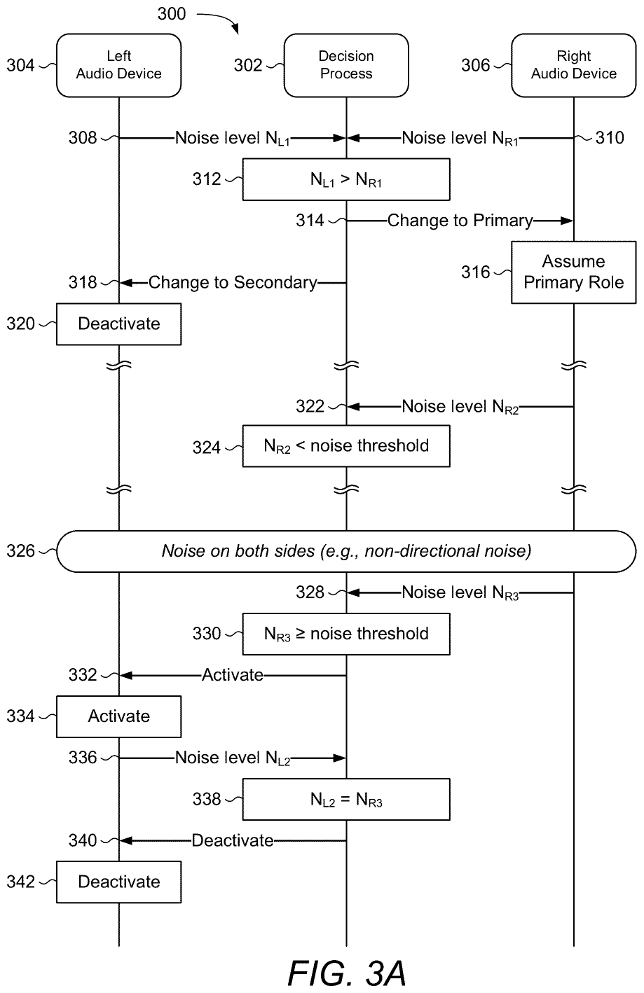

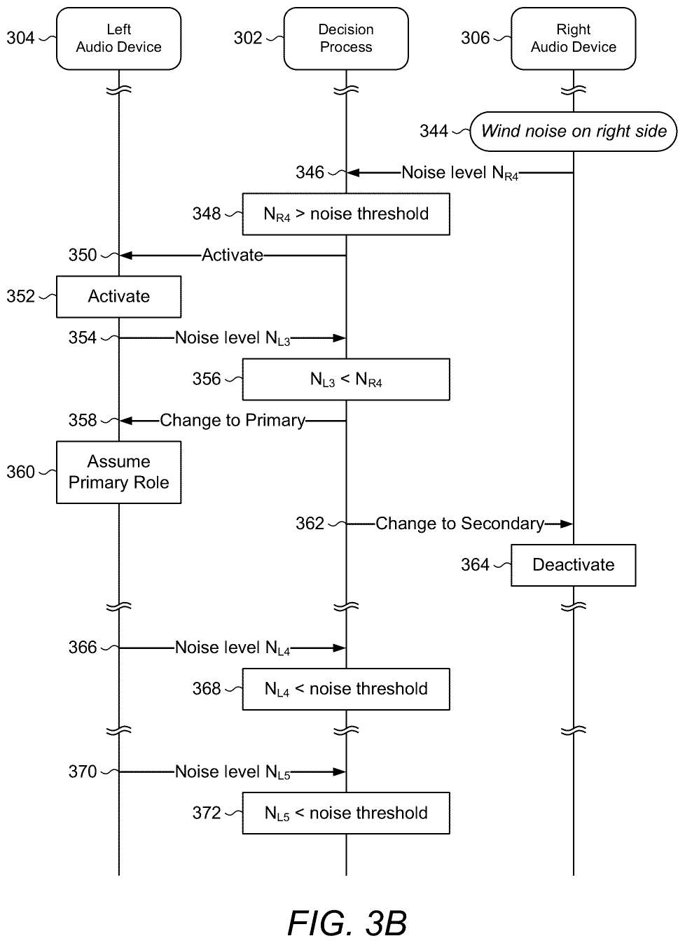

FIG. 3A and FIG. 3B are signaling and event diagrams illustrating portions of a process 300 for audio processing handover between audio devices according to aspects of the disclosure. FIGS. 3A and 3B illustrate an approach, performed by a decision process 302, in which a directional noise source is detected based on noise levels of audio signals at the two audio devices: left audio device 304 and right audio device 306. The audio device having the lower noise level will be primary audio input device and will perform the voice processing algorithms. The audio device having the higher noise level will be the secondary audio input device and will not perform any voice processing algorithms, and, in some aspects, will power down its microphone, reduce its processor load, take other actions to reduce its power consumption, or a combination thereof. The decision process 302 may be performed by the left audio device 304, the right audio device 306, another component not shown, the processor(s) of any of the above, or some combination thereof.

In this approach, directional noise is detected by means of the noise level difference between two audio devices (e.g., between two earbuds), and to switch the primary to the side with the lower noise level. In some aspects, a simple process will reside in each earbud to calculate frame-based root-mean-square (RMS) values. In some aspects, this is confined to a specific frequency range with the help of an equalization stage. For example, human auditory perception utilizes interaural level difference (ILD) at frequencies above approximately 1.5 kHz.

As shown in FIG. 3A, at block 308, the left audio device 304 sends to the decision process 302 a first indication of the noise level on the audio from left audio device 304 (N_{L1}), and at block 320, the right audio device 306 sends to the decision process 302 a first indication of the noise level on the audio from the right audio device 306 (N_{R1}). At block 312, the decision process 302 determines that the noise level on the left audio device 304 is greater than the noise level on the right audio device 306 (e.g., N_{L1}>N_{R1}). At block 314, the decision process 302 instructs the right audio device 306 to assume the primary role, and at block 316, the right audio device 306 does assume the primary role, e.g., performing the voice processing algorithms, etc. At block 318, the decision process 302 instructs the left audio device 304 to assume the secondary role, and at block 320, the left audio device 304 does assume the secondary role, e.g., by deactivating some or all of the processes previously being performed, and in some cases powering down portions of the hardware to save battery power.

As further shown in FIG. 3A, at block 322, the right audio device 306 sends to the decision process 302 a second indication of a noise level on the right audio device 306 (N_{R2}). At block 324, the decision process 302 determines that N_{R2} is less than a noise threshold. Because N_{R2} is less than the noise threshold, this does not trigger a potential handover process, and so nothing further is done in that regard by the decision process 302.

As further shown in FIG. 3A, at block 326, there is non-directional noise on both audio devices (or directional noise that affects both sides essentially equally). At block 328, the right audio device 306 sends to the decision process 302 a third indication of a noise level on the right audio device 306 (N_{R3}). At block 330, the decision process 302 determines that N_{R3} is greater than the noise threshold. In the example illustrated in FIG. 3A, this condition triggers a potential handover, so at block 332, the decision process 302 activates the left audio device 304. At block 334, the left audio device 304 activates, and at block 336, the activated left audio device 304 provides a second indication of a noise level on the left audio device 304 (N_{L2}) to the decision process 302. In this example, at block 338, the decision process 302 determines the noise level on the left audio device 304 is the same as the noise level on the right audio device 306 (e.g., N_{L2}=N_{R3}), and so there is no benefit to having the left audio device 304 take over the primary role from the right audio device 306. Thus, at block 340, the decision process 302 instructs the left audio device 304 to deactivate, and at block 342, the left audio device 304 does deactivate. The example continues in FIG. 3B.

As shown in FIG. 3B, at block 344, there is wind noise (or other directional noise) on the right audio device. At block 346, the right audio device 306 sends to the decision process 302 a fourth indication of a noise level on the right audio device 306 (N_{R4}). At block 348, the decision process 302 determines that N_{R4} is greater than the noise threshold. In the example illustrated in FIG. 3B, this condition triggers a potential handover, so at block 350, the decision process 302 activates the left audio device 304. At block 352, the left audio device 304 activates. At block 354, the activated left audio device 304 provides a third indication of a noise level on the left audio device 304 (N_{L3}) to the decision process 302.

In this example, at block 356, the decision process 302 determines that the noise level on the left audio device 304 is less than the noise level on the right audio device 306 (e.g., N_{L3}<N_{R4}), and so there is a benefit to having the left audio device 304 take over the primary role from the right audio device 306. That is, the decision process 302 determines that a handover should occur. Thus, at block 358, the decision process 302 instructs the left audio device 304 to assume the primary role, and at block 360, the left audio device 304 assumes the primary role. At block 362, the decision process 302 instructs the right audio device 306 to change to secondary, and at block 364, the right audio device 306 assumes the secondary role, e.g., it deactivates.

In the example shown in FIG. 3B, the left audio device 304, as primary, periodically sends noise levels to the decision process 302. For example, at block 366, the left audio device 304 sends to the decision process 302 a fourth indication of a noise level on the left audio device 304 (N_{L4}). At block 368, the decision process 302 determines that N_{L4} is less than the noise threshold and thus no handover is needed. At block 370, the left audio device 304 sends to the decision process 302 a fifth indication of a noise level on the left audio device 304 (N_{L5}). At block 368, the decision process 302 determines that N_{L5} is less than the noise threshold and thus again, no handover is needed.

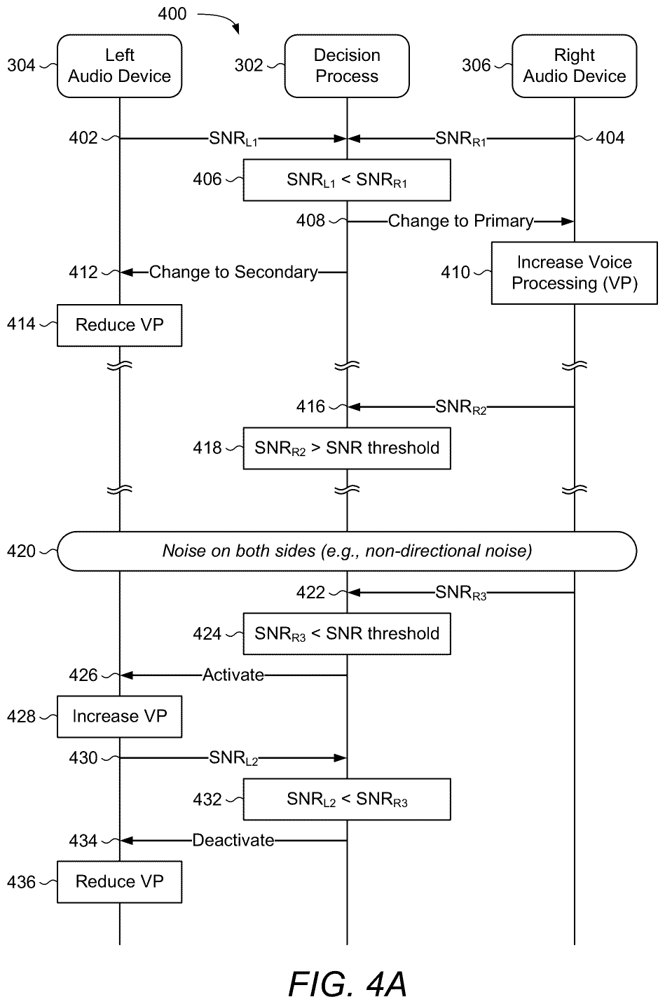

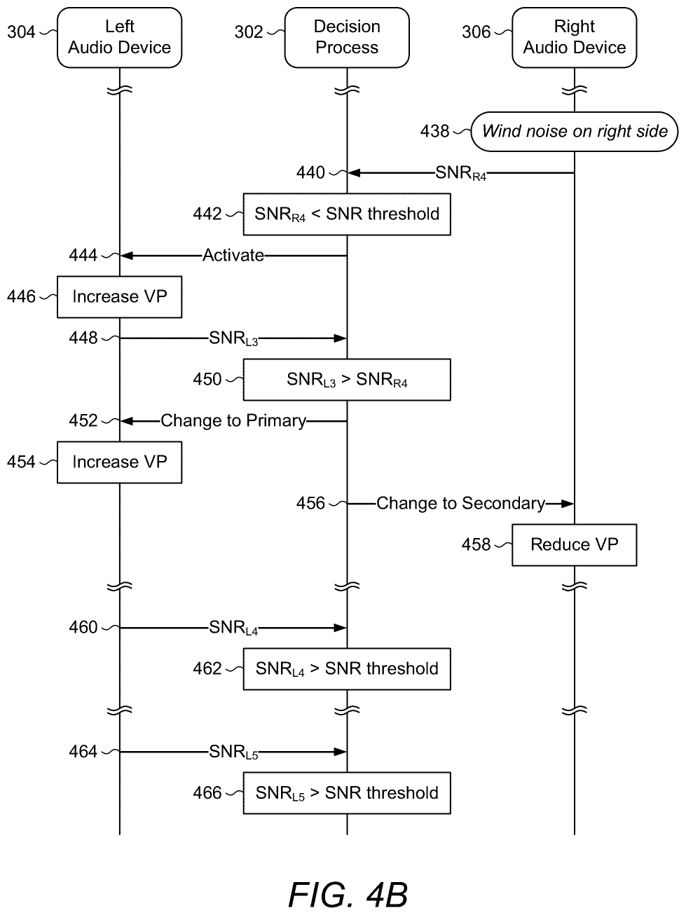

FIG. 4A and FIG. 4B are signaling and event diagrams illustrating portions of a process 400 for audio processing handover between audio devices according to aspects of the disclosure. FIGS. 4A and 4B illustrate an approach, performed by a decision process 302, in which a directional noise source is detected based on SNR of audio signals at the two audio devices: left audio device 304 and right audio device 306. The audio device having the higher SNR will be primary audio input device and will perform the voice processing algorithms. The audio device having the lower SNR will be the secondary audio input device and will not perform any voice processing algorithms, and, in some aspects, will power down its microphone, reduce its processor load, take other actions to reduce its power consumption, or a combination thereof. The decision process 302 may be performed by the left audio device 304, the right audio device 306, another component not shown, the processor(s) of any of the above, or some combination thereof.

As shown in FIG. 4A, at block 402, the left audio device 304 sends to the decision process 302 a first indication of the SNR of the audio from the left audio device 304 (SNR_{L1}), and at block 404, the right audio device 306 sends to the decision process 302 a first indication of the SNR of the audio from the right audio device 306 (SNR_{R1}). At block 406, the decision process 302 determines that the SNR on the left audio device 304 is less than the SNR on the right audio device 306 (e.g., SNR_{L1}<SNR_{R1}). At block 408, the decision process 302 instructs the right audio device 306 to assume the primary role, and at block 410, the right audio device 306 does assume the primary role, e.g., by increasing the amount of voice processing (VP) that the right audio device 306 performs. At block 412, the decision process 302 instructs the left audio device 304 to assume the secondary role, and at block 414, the left audio device 304 does assume the secondary role, e.g., by reducing the amount of VP that the left audio device 304 performs.

As further shown in FIG. 4A, at block 416, the right audio device 306 sends to the decision process 302 a second indication of the SNR on the right audio device 306 (SNR_{R2}). At block 418, the decision process 302 determines that SNR_{R2} is greater than an SNR threshold. Because SNR_{R2} is greater than the SNR threshold, this does not trigger a potential handover process, and so nothing further is done in that regard by the decision process 302.

As further shown in FIG. 4A, at block 420, there is non-directional noise on both audio devices (or directional noise that affects both sides essentially equally). At block 422, the right audio device 306 sends to the decision process 302 a third indication of the SNR on the right audio device 306 (SNR_{R3}). At block 424, the decision process 302 determines that SNR_{R3} is less than the SNR threshold. In the example illustrated in FIG. 4A, this condition triggers a potential handover, so at block 426, the decision process 302 activates the left audio device 304. At block 428, the left audio device 304 activates and increases VP, and at block 430, the activated left audio device 304 provides a second indication of the SNR on the left audio device 304 (SNR_{L2}) to the decision process 302. In this example, at block 432, the decision process 302 determines the SNR on the left audio device 304 is less than the SNR on the right audio device 306 (e.g., SNR_{L2}<SNR_{R3}), and so there is no benefit to having the left audio device 304 take over the primary role from the right audio device 306. Thus, at block 434, the decision process 302 instructs the left audio device 304 to deactivate, and at block 436, the left audio device 304 does deactivate and decreases VP. The example continues in FIG. 4B.

As shown in FIG. 4B, at block 438, there is wind noise (or other directional noise) on the right audio device. At block 440, the right audio device 306 sends to the decision process 302 a fourth indication of the SNR on the right audio device 306 (SNR_{R4}). At block 442, the decision process 302 determines that SNR_{R4} is less than the SNR threshold. In the example illustrated in FIG. 4B, this condition triggers a potential handover, so at block 444, the decision process 302 activates the left audio device 304. At block 446, the left audio device 304 activates and increases VP. At block 448, the activated left audio device 304 provides a third indication of the SNR on the left audio device 304 (SNR_{L3}) to the decision process 302.

In this example, at block 450, the decision process 302 determines that the SNR on the left audio device 304 is greater than the SNR on the right audio device 306 (e.g., SNR_{L3}>SNR_{R4}), and so there is a benefit to having the left audio device 304 take over the primary role from the right audio device 306. That is, the decision process 302 determines that a handover should occur. Thus, at block 452, the decision process 302 instructs the left audio device 304 to assume the primary role, and at block 454, the left audio device 304 assumes the primary role and increases VP. At block 456, the decision process 302 instructs the right audio device 306 to change to secondary, and at block 458, the right audio device 306 assumes the secondary role and decreases VP.

In the example shown in FIG. 4B, the left audio device 304, as primary, periodically sends SNRs to the decision process 302. For example, at block 460, the left audio device 304 sends to the decision process 302 a fourth indication of the SNR on the left audio device 304 (SNR_{L4}). At block 462, the decision process 302 determines that SNR_{L4} is greater than the SNR threshold and thus no handover is needed. At block 464, the left audio device 304 sends to the decision process 302 a fifth indication of the SNR on the left audio device 304 (SNR_{L5}). At block 466, the decision process 302 determines that SNR_{L5} is greater than the SNR threshold and thus again, no handover is needed.

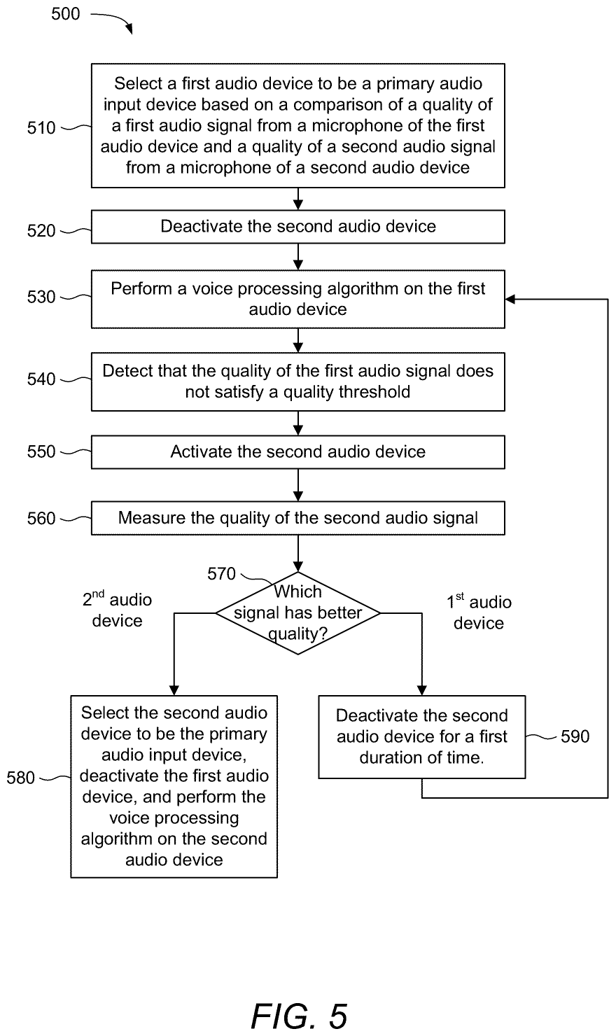

FIG. 5 is a flowchart of an example process 500 associated with audio processing handover between audio devices, according to aspects of the disclosure. In some implementations, one or more process blocks of FIG. 5 may be performed by an audio device (e.g., audio devices 112A, 112B, 304, 306, etc.). In some implementations, one or more process blocks of FIG. 5 may be performed by another device or a group of devices separate from or including the device. Additionally, or alternatively, one or more process blocks of FIG. 5 may be performed by one or more components of an apparatus, such as processor(s), memory, or transceiver(s), any or all of which may be means for performing the operations of process 500.

As shown in FIG. 5, process 500 may include, at block 510, selecting a first audio device to be a primary audio input device based on a comparison of a quality of a first audio signal from a microphone of the first audio device and a quality of a second audio signal from a microphone of a second audio device. Means for performing the operation of block 510 may include the processor(s), memory, or transceiver(s) of any of the apparatuses described herein. For example, a processor 106 may select a first audio device to be a primary audio input device based on a comparison of a quality of a first audio signal from a microphone 102 of the first audio device and a quality of a second audio signal from a microphone 102 of a second audio device.

As further shown in FIG. 5, process 500 may include, at block 520, deactivating the second audio device. Means for performing the operation of block 520 may include the processor(s), memory, or transceiver(s) of any of the apparatuses described herein. For example, a processor 106 may deactivate the second audio device, by sending a message via the transceiver(s) 110.

As further shown in FIG. 5, process 500 may include, at block 530, performing a voice processing algorithm on the first audio device. Means for performing the operation of block 530 may include the processor(s), memory, or transceiver(s) of any of the apparatuses described herein. For example, a processor 106 may perform a voice processing algorithm on the first audio device, using data received from microphone(s) 102 and optionally stored in memory 108.

As further shown in FIG. 5, process 500 may include, at block 540, detecting that the quality of the first audio signal does not satisfy a quality threshold. Means for performing the operation of block 540 may include the processor(s), memory, or transceiver(s) of any of the apparatuses described herein. For example, a processor 106 may determine that the audio signal from the microphone(s) 102 has a noise level that exceeds a threshold value stored in memory 108; the processor 106 may determine that the SNR of the audio signal from the microphone(s) 102 does not meet a minimum SNR threshold level stored in memory 108; the processor 106 may determine that the result of a voice processing algorithm does not meet some threshold requirement; or a combination of the above.

As further shown in FIG. 5, process 500 may include, at block 550, activating the second audio device. Means for performing the operation of block 550 may include the processor(s), memory, or transceiver(s) of any of the apparatuses described herein. For example, a processor 106 may send a message to the other audio device via the transceiver(s) 110.

As further shown in FIG. 5, process 500 may include, at block 560, measuring the quality of the second audio signal. Means for performing the operation of block 560 may include the processor(s), memory, or transceiver(s) of any of the apparatuses described herein. For example, a processor 106 on the primary audio device may receive, from the secondary audio device, an indication of the quality of the audio signal at the secondary audio device, via the transceiver(s) 110.

As further shown in FIG. 5, process 500 may include, at block 570, determining whether the quality of the second audio signal is better than the quality of the first audio signal. Means for performing the operation of block 570 may include the processor(s), memory, or transceiver(s) of any of the apparatuses described herein. For example, a processor 106 can perform a comparison of the quality of the first audio signal and the quality of the second audio signal. In the example shown in FIG. 5, if the quality of the second audio signal is better than the first audio signal, the process moves to block 580, and if the quality of the second audio signal is not better than the first audio signal, the process moves to block 590.

As further shown in FIG. 5, process 500 may include, at block 580, selecting the second audio device to be the primary audio input device, deactivating the first audio device, and performing the voice processing algorithm on the second audio device. Means for performing the operation of block 580 may include the processor(s), memory, or transceiver(s) of any of the apparatuses described herein. For example the processor 106 on the first audio device can use the transceiver(s) 110 to send instructions to the second audio device, then deactivate itself or reduce its processing or voice processing task load. Likewise, the second audio device may receive instructions to assume the role of primary audio device via its transceiver(s) 110, and its processor 106 can execute the commands necessary to assume the role of primary, including starting tasks, invoking processes, activating microphone hardware, etc.

As further shown in FIG. 5, process 500 may include, at block 590, deactivating the second audio device for a first duration of time. Means for performing the operation of block 590 may include the processor(s), memory, or transceiver(s) of any of the apparatuses described herein. For example, the processor 106 of the first audio device may use the transceiver(s) 1100 to instruct the second audio device to maintain its role as secondary, which may include deactivating portions of the second audio device.

In some aspects, selecting the first audio device to be the primary audio input device based on the comparison of the quality of the first audio signal and the quality of the second audio signal comprises selecting the first audio device based on a comparison of a signal level of the first audio signal and a signal level of the second audio signal, a comparison of a signal to noise ratio of the first audio signal and a signal to noise ratio of the second audio signal, or a combination thereof.

In some aspects, deactivating the first or second audio device comprises disabling the voice processing algorithm from being performed by the first or second audio device, disabling transmission of the second audio signal from the first or second audio device, reducing a power consumption of the first or second audio device, or a combination thereof.

In some aspects, performing the voice processing algorithm comprises performing a voice activity detection (VAD) algorithm, a voice enhancement algorithm, or a combination thereof.

In some aspects, detecting that the quality of the first audio signal does not satisfy the quality threshold comprises detecting that an audio signal level of the first audio signal does not satisfy an audio signal level threshold, detecting that an audio signal to noise ratio (SNR) of the first audio signal does not satisfy an audio SNR threshold, detecting that a microphone quality parameter provided by the first audio device does not satisfy a microphone quality parameter threshold, detecting that a wind noise on the first audio signal exceeds a maximum wind noise threshold, detecting that a radio frequency (RF) signal level of the first audio signal does not satisfy a RF signal level threshold, detecting that an RF SNR of the first audio signal does not satisfy an RF SNR threshold, or a combination thereof.

In some aspects, measuring the quality of the second audio signal comprises measuring an audio signal level of the second audio signal, an audio signal to noise ratio (SNR) of the second audio signal, a wind noise on the second audio signal, a radio frequency (RF) signal level of the second audio signal, an RF SNR of the second audio signal, or a combination thereof.

In some aspects, the second audio device further comprises a bone conduction microphone (BCM) and wherein an audio signal from the BCM is not considered when measuring the quality of the second audio signal.

In some aspects, the first duration of time is selected based on the quality of the second audio signal.

In some aspects, process 500 includes, after the first duration of time, checking the quality of the first audio signal, upon detecting that the quality of the first audio signal does not satisfy the quality threshold activating the second audio device, measuring the quality of the second audio signal, upon determining that the quality of the second audio signal is better than the quality of the first audio signal, selecting the second audio device to be the primary audio input device, deactivating the first audio device, and performing the voice processing algorithm on the second audio device, and upon determining that the quality of the second audio signal is not better than the quality of the first audio signal, deactivating the second audio device for the first duration of time.

In some aspects, the first audio device is located in a first housing and wherein the second audio device is located in a second housing.

In some aspects, the first housing comprises a first earbud and the second housing comprises a second earbud.

In some aspects, the first audio device is located in a first housing and wherein the second audio device is located in the first housing.

In some aspects, the first housing comprises a head-mounted device.

Process 500 may include additional implementations, such as any single implementation or any combination of implementations described below and/or in connection with one or more other processes described elsewhere herein. Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

### Use Cases

In an example implementation, QUALCOMM's application developer kit (ADK) includes a handover decision making algorithm (HDMA), which monitors various conditions from both earbuds to decide primary handover, including determining that the primary earbud is taken off the ear, that the battery level has become low, or that the RF signal has become too weak. Some of the parameters used by the HDMA are listed in the table below:

| | Reception | |
|---|---|---|
| Parameter | criteria | Notes |
| Physical | Received on | Four possible states: |
| state | physical | IN_CASE, OUT_OF_CASE, IN_EAR, |
| | state change | and OUT_OF_EAR. The HDMA triggers a |
| | | handover when the primary earbud moves |
| | | from IN_EAR to OUT_OF_EAR state. |
| | | Before recommending a handover, the |
| | | HDMA checks the secondary earbud |
| | | placement, and will only recommend a |
| | | handover when the secondary is IN_EAR. |
| Battery | Received on | Three battery levels: critical, high, and low. |
| level | battery level | Battery levels are set based on the battery |
| | state change | voltage. The state proxy notifies the HDMA |
| | | when voltage level changes. |
| Mic | Streamed at | The mic quality event ranges from 0 to 15 |
| quality | 2 Hz during an | (where 0 is worst and 15 is best). Each event |
| | active call | is valid up to critical Max Age and Half Life. |
| Received | Streamed at | The RSSI value event ranges from −90 |
| signal | 2 Hz | to −30 (where −90 is worst and −30 |
| strength | (continuous) | is best). Each event is valid up to critical |
| indicator | | Max Age and Half Life. |
| (RSSI) | | |

If the earbud has an in-ear sensor it can distinguish between out of ear and in ear states. If an earbud does not have an in-ear sensor, it assumes that when it is not in the case, it is in the ear. The HDMA receives inputs from both primary and secondary earbuds and when necessary recommends a handover with the following information: the reason for the handover, handover urgency (critical, high, or low), and a timestamp.

Handover based on noise comparison. In some aspects, the mic quality parameter is used as the basis for detection of a potential handover condition, e.g., to switch the primary role to the side with the lower noise level on the microphones. This parameter, ranging from 0 to 15, is received by the HDMA twice a second from one or both earbuds. Using this information along with a pre-set threshold and time history, HDMA can recommend a handover of the primary role. In some aspects, this “voice quality” parameter becomes a frame-based microphone RMS value.

For example, in one implementation, the noise level information is streamed to the HDMA, as the mic quality parameter but in a slightly modified format to have a better resolution if required. The HDMA may then keep track of the microphone signal levels in terms of a weighted moving average to prevent fluctuations resulting in too quick handovers. If the Left-Right microphone level difference crosses a previously tuned threshold, then in addition to all the other existing handover conditions, the HDMA can recommend handover to the side with the lower microphone signal level.

In typical use cases where the user wears both earbuds correctly without a big fit difference, this method of monitoring the external microphone level would ensure the best SNR possible, because the users voice level would be the same on both sides. One advantage of this technique is that all the higher-level signal processing towards voice enhancement can follow this decision once the side with lower noise level is identified, the more complex voice enhancement algorithms can be switched off on the opposite earbud, until the HDMA requires another switching.

By utilizing the existing communication channel with a very light additional calculation step, it is possible to save the processing power to run the voice enhancement algorithm on both sides. An additional benefit of this technique is that it can be possible to extract user voice to support Voice Activity Detection (VAD), if a BCM is also available. It is known that BCMs reject external noise with frequencies up to 1 kHz. When a BCM is additionally utilized to a typical external microphone, the BCM signal below 1 kHz can be considered to contain the wanted voice signal on both sides, whereas the external microphone would contain the mixture of the voice and the noise, which will show larger left-right difference in the presence of directional noise. Again, a simple comparison of these two signals in the time domain can help a more complex algorithm that needs to run VAD and to accurately calculate the SNR information, such as QUALCOMM's clear Voice capture (cVc).

Handover based on SNR calculation. This method utilizes the SNR as the information to be shared across the earbuds. QUALCOMM's cVc system has an internal algorithm to calculate SNR from the microphone signals, which is used to control the algorithm itself, e.g., the hybrid voice enhancement technique as described earlier. So far, the SNR information has been used only per side. However, with the existing HDMA channel, it is now possible to compare the SNR between the two earbuds. Recent internal evaluation of noise suppression-voice enhancement algorithms revealed that QUALCOMM's cVc performs better than other internal competitors with more complex techniques in high-SNR conditions.

The HDMA can recommend the handover by comparing the SNR from both sides. This way, the cVc algorithm can give the best possible output from the side with the higher SNR. The other side can then relax the processing to save power for example, a 3-mic mode can be switched to a 2-mic mode or even cVc send part can be completely switched off. This will therefore not only be beneficial in enhancing the cVc performance but also in power saving. HDMA can lead running cVc 3 mic mode on a noisy side, to cVc 2mic mode on a less noisy side which can reduce power consumption of cVc about 40%.

This method makes use of the actual SNR as the final KPI needed for cVc operation, rather than the raw microphone signal levels that are correlated with the SNR. With the help of additional computation (of running cVc modules on both sides), this can provide a more robust handover determination in some specific cases where there is a left-right difference in the noise level, but also in the user's voice leading to SNR difference in the opposite direction. In some aspects this voice quality parameter is derived based on SNR and wind strength estimation from cVc.

The techniques provided herein provide a number of technical advantages, including, but not limited to the following. They provide a smaller processing overhead (e.g., disabling the non-primary audio device and checking whether the non-primary audio device would actually provide a better audio signal only when the primary microphone audio signal fails some quality threshold) to avoid having to perform a larger processing step (e.g., continually monitoring the non-primary audio device). For example, rather than running the cVc algorithm on both sides during a voice call, a simple time-domain RMS step can help switch off one side or the other, or reduce the number of cVc processes performed by the non-primary audio device.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:
Clause 1. A method of audio processing handover between audio devices, the method comprising: selecting a first audio device to be a primary audio input device based on a comparison of a quality of a first audio signal from a microphone of the first audio device and a quality of a second audio signal from a microphone of a second audio device; deactivating the second audio device; performing a voice processing algorithm on the first audio device; detecting that the quality of the first audio signal does not satisfy a quality threshold, and in response: activating the second audio device; measuring the quality of the second audio signal; upon determining that the quality of the second audio signal is better than the quality of the first audio signal, selecting the second audio device to be the primary audio input device, deactivating the first audio device, and performing the voice processing algorithm on the second audio device; and upon determining that the quality of the second audio signal is not better than the quality of the first audio signal, deactivating the second audio device for a first duration of time.
Clause 2. The method of clause 1, wherein selecting the first audio device to be the primary audio input device based on the comparison of the quality of the first audio signal and the quality of the second audio signal comprises selecting the first audio device based on a comparison of a signal level of the first audio signal and a signal level of the second audio signal, a comparison of a signal to noise ratio of the first audio signal and a signal to noise ratio of the second audio signal, or a combination thereof
Clause 3. The method of any of clauses 1 to 2, wherein deactivating the first or second audio device comprises: disabling the voice processing algorithm from being performed by the first or second audio device; disabling transmission of the second audio signal from the first or second audio device; reducing a power consumption of the first or second audio device; or a combination thereof
Clause 4. The method of any of clauses 1 to 3, wherein performing the voice processing algorithm comprises performing a voice activity detection (VAD) algorithm, a voice enhancement algorithm, or a combination thereof
Clause 5. The method of any of clauses 1 to 4, wherein detecting that the quality of the first audio signal does not satisfy the quality threshold comprises: detecting that an audio signal level of the first audio signal does not satisfy an audio signal level threshold; detecting that an audio signal to noise ratio (SNR) of the first audio signal does not satisfy an audio SNR threshold; detecting that a microphone quality parameter provided by the first audio device does not satisfy a microphone quality parameter threshold; detecting that a wind noise on the first audio signal exceeds a maximum wind noise threshold; detecting that a radio frequency (RF) signal level of the first audio signal does not satisfy a RF signal level threshold; detecting that an RF SNR of the first audio signal does not satisfy an RF SNR threshold; or a combination thereof
Clause 6. The method of any of clauses 1 to 5, wherein measuring the quality of the second audio signal comprises measuring: an audio signal level of the second audio signal; an audio signal to noise ratio (SNR) of the second audio signal; a wind noise on the second audio signal; a radio frequency (RF) signal level of the second audio signal; an RF SNR of the second audio signal; or a combination thereof.
Clause 7. The method of clause 6, wherein the second audio device further comprises a bone conduction microphone (BCM) and wherein an audio signal from the BCM is not considered when measuring the quality of the second audio signal.
Clause 8. The method of any of clauses 1 to 7, wherein the first duration of time is selected based on the quality of the second audio signal.
Clause 9. The method of any of clauses 1 to 8, further comprising, upon determining that the quality of the second audio signal is not better than the quality of the first audio signal and deactivating the second audio device for the first duration of time: after the first duration of time, checking the quality of the first audio signal; upon detecting that the quality of the first audio signal does not satisfy the quality threshold: activating the second audio device; measuring the quality of the second audio signal; upon determining that the quality of the second audio signal is better than the quality of the first audio signal, selecting the second audio device to be the primary audio input device, deactivating the first audio device, and performing the voice processing algorithm on the second audio device; and upon determining that the quality of the second audio signal is not better than the quality of the first audio signal, deactivating the second audio device for the first duration of time.
Clause 10. The method of any of clauses 1 to 9, wherein the first audio device is located in a first housing and wherein the second audio device is located in a second housing.
Clause 11. The method of clause 10, wherein the first housing comprises a first earbud and the second housing comprises a second earbud.
Clause 12. The method of any of clauses 1 to 11, wherein the first audio device is located in a first housing and wherein the second audio device is located in the first housing.
Clause 13. The method of clause 12, wherein the first housing comprises a head-mounted device.
Clause 14. An audio system, comprising: a first audio device and a second audio device, each audio device comprising a microphone, a transceiver, a memory, and at least one processor coupled to the memory and the transceiver, the at least one processor configured to: select the first audio device to be a primary audio input device based on a comparison of a quality of a first audio signal from a microphone of the first audio device and a quality of a second audio signal from a microphone of the second audio device; deactivate the second audio device; perform a voice processing algorithm on the first audio device; detect that the quality of the first audio signal does not satisfy a quality threshold, and in response: activate the second audio device; measure the quality of the second audio signal; upon determining that the quality of the second audio signal is better than the quality of the first audio signal, select the second audio device to be the primary audio input device, deactivate the first audio device, and perform the voice processing algorithm on the second audio device; and upon determining that the quality of the second audio signal is not better than the quality of the first audio signal, deactivate the second audio device for a first duration of time.
Clause 15. The audio system of clause 14, wherein, to select the first audio device to be the primary audio input device based on the comparison of the quality of the first audio signal and the quality of the second audio signal, the at least one processor is configured to select the first audio device based on a comparison of a signal level of the first audio signal and a signal level of the second audio signal, a comparison of a signal to noise ratio of the first audio signal and a signal to noise ratio of the second audio signal, or a combination thereof
Clause 16. The audio system of any of clauses 14 to 15, wherein, to deactivate the first or second audio device, the at least one processor is configured to: disable the voice processing algorithm from being performed by the first or second audio device; disable transmission of the second audio signal from the first or second audio device; reduce a power consumption of the first or second audio device; or a combination thereof
Clause 17. The audio system of any of clauses 14 to 16, wherein, to perform the voice processing algorithm, the at least one processor is configured to perform a voice activity detection (VAD) algorithm, a voice enhancement algorithm, or a combination thereof
Clause 18. The audio system of any of clauses 14 to 17, wherein, to detect that the quality of the first audio signal does not satisfy the quality threshold, the at least one processor is configured to: detect that an audio signal level of the first audio signal does not satisfy an audio signal level threshold; detect that an audio signal to noise ratio (SNR) of the first audio signal does not satisfy an audio SNR threshold; detect that a microphone quality parameter provided by the first audio device does not satisfy a microphone quality parameter threshold; detect that a wind noise on the first audio signal exceeds a maximum wind noise threshold; detect that a radio frequency (RF) signal level of the first audio signal does not satisfy a RF signal level threshold; detect that an RF SNR of the first audio signal does not satisfy an RF SNR threshold; or a combination thereof.
Clause 19. The audio system of any of clauses 14 to 18, wherein, to measure the quality of the second audio signal, the at least one processor is configured to measure: an audio signal level of the second audio signal; an audio signal to noise ratio (SNR) of the second audio signal; a wind noise on the second audio signal; a radio frequency (RF) signal level of the second audio signal; an RF SNR of the second audio signal; or a combination thereof
Clause 20. The audio system of clause 19, wherein the second audio device further comprises a bone conduction microphone (BCM) and wherein an audio signal from the BCM is not considered when measuring the quality of the second audio signal.
Clause 21. The audio system of any of clauses 14 to 20, wherein the first duration of time is selected based on the quality of the second audio signal.
Clause 22. The audio system of any of clauses 14 to 21, wherein the at least one processor is further configured to, upon determining that the quality of the second audio signal is not better than the quality of the first audio signal and deactivating the second audio device for the first duration of time: after the first duration of time, check the quality of the first audio signal; upon detecting that the quality of the first audio signal does not satisfy the quality threshold: activate the second audio device; measure the quality of the second audio signal; upon determining that the quality of the second audio signal is better than the quality of the first audio signal, select the second audio device to be the primary audio input device, deactivate the first audio device, and perform the voice processing algorithm on the second audio device; and upon determining that the quality of the second audio signal is not better than the quality of the first audio signal, deactivate the second audio device for the first duration of time.
Clause 23. The audio system of any of clauses 14 to 22, wherein the first audio device is located in a first housing and wherein the second audio device is located in a second housing.
Clause 24. The audio system of clause 23, wherein the first housing comprises a first earbud and the second housing comprises a second earbud.
Clause 25. The audio system of any of clauses 14 to 24, wherein the first audio device is located in a first housing and wherein the second audio device is located in the first housing.
Clause 26. The audio system of clause 25, wherein the first housing comprises a head-mounted device.
Clause 27. An audio system, comprising: means for selecting a first audio device to be a primary audio input device based on a comparison of a quality of a first audio signal from a microphone of the first audio device and a quality of a second audio signal from a microphone of a second audio device; means for deactivating the second audio device; means for performing a voice processing algorithm on the first audio device; means for detecting that the quality of the first audio signal does not satisfy a quality threshold, and in response: activating the second audio device; measuring the quality of the second audio signal; upon determining that the quality of the second audio signal is better than the quality of the first audio signal, selecting the second audio device to be the primary audio input device, deactivating the first audio device, and performing the voice processing algorithm on the second audio device; and upon determining that the quality of the second audio signal is not better than the quality of the first audio signal, deactivating the second audio device for a first duration of time.
Clause 28. The audio system of clause 27, wherein the means for selecting the first audio device to be the primary audio input device based on the comparison of the quality of the first audio signal and the quality of the second audio signal comprises means for selecting the first audio device based on a comparison of a signal level of the first audio signal and a signal level of the second audio signal, a comparison of a signal to noise ratio of the first audio signal and a signal to noise ratio of the second audio signal, or a combination thereof
Clause 29. The audio system of any of clauses 27 to 28, wherein the means for deactivating the first or second audio device comprises: means for disabling the voice processing algorithm from being performed by the first or second audio device; means for disabling transmission of the second audio signal from the first or second audio device; means for reducing a power consumption of the first or second audio device; or a combination thereof
Clause 30. The audio system of any of clauses 27 to 29, wherein the means for performing the voice processing algorithm comprises means for performing a voice activity detection (VAD) algorithm, a voice enhancement algorithm, or a combination thereof
Clause 31. The audio system of any of clauses 27 to 30, wherein the means for detecting that the quality of the first audio signal does not satisfy the quality threshold comprises: means for detecting that an audio signal level of the first audio signal does not satisfy an audio signal level threshold; means for detecting that an audio signal to noise ratio (SNR) of the first audio signal does not satisfy an audio SNR threshold; means for detecting that a microphone quality parameter provided by the first audio device does not satisfy a microphone quality parameter threshold; means for detecting that a wind noise on the first audio signal exceeds a maximum wind noise threshold; means for detecting that a radio frequency (RF) signal level of the first audio signal does not satisfy a RF signal level threshold; means for detecting that an RF SNR of the first audio signal does not satisfy an RF SNR threshold; or a combination thereof
Clause 32. The audio system of any of clauses 27 to 31, wherein the means for measuring the quality of the second audio signal comprises means for measuring: an audio signal level of the second audio signal; an audio signal to noise ratio (SNR) of the second audio signal; a wind noise on the second audio signal; a radio frequency (RF) signal level of the second audio signal; an RF SNR of the second audio signal; or a combination thereof
Clause 33. The audio system of clause 32, wherein the second audio device further comprises a bone conduction microphone (BCM) and wherein an audio signal from the BCM is not considered when measuring the quality of the second audio signal.
Clause 34. The audio system of any of clauses 27 to 33, wherein the first duration of time is selected based on the quality of the second audio signal.
Clause 35. The audio system of any of clauses 27 to 34, further comprising, means for, upon determining that the quality of the second audio signal is not better than the quality of the first audio signal and deactivating the second audio device for the first duration of time: after the first duration of time, checking the quality of the first audio signal; upon detecting that the quality of the first audio signal does not satisfy the quality threshold: activating the second audio device; measuring the quality of the second audio signal; upon determining that the quality of the second audio signal is better than the quality of the first audio signal, selecting the second audio device to be the primary audio input device, deactivating the first audio device, and performing the voice processing algorithm on the second audio device; and upon determining that the quality of the second audio signal is not better than the quality of the first audio signal, deactivating the second audio device for the first duration of time.
Clause 36. The audio system of any of clauses 27 to 35, wherein the first audio device is located in a first housing and wherein the second audio device is located in a second housing.
Clause 37. The audio system of clause 36, wherein the first housing comprises a first earbud and the second housing comprises a second earbud.
Clause 38. The audio system of any of clauses 27 to 37, wherein the first audio device is located in a first housing and wherein the second audio device is located in the first housing.
Clause 39. The audio system of clause 38, wherein the first housing comprises a head-mounted device.
Clause 40. A non-transitory computer-readable medium storing computer-executable instructions that, when executed by an audio system, cause the audio system to: select a first audio device to be a primary audio input device based on a comparison of a quality of a first audio signal from a microphone of the first audio device and a quality of a second audio signal from a microphone of a second audio device; deactivate the second audio device; perform a voice processing algorithm on the first audio device; detect that the quality of the first audio signal does not satisfy a quality threshold, and in response: activating the second audio device; measuring the quality of the second audio signal; upon determining that the quality of the second audio signal is better than the quality of the first audio signal, selecting the second audio device to be the primary audio input device, deactivating the first audio device, and performing the voice processing algorithm on the second audio device; and upon determining that the quality of the second audio signal is not better than the quality of the first audio signal, deactivating the second audio device for a first duration of time.
Clause 41. The non-transitory computer-readable medium of any of clauses 27 to 40, wherein the computer-executable instructions that, when executed by the audio system, cause the audio system to select the first audio device to be the primary audio input device based on the comparison of the quality of the first audio signal and the quality of the second audio signal comprise computer-executable instructions that, when executed by the audio system, cause the audio system to select the first audio device based on a comparison of a signal level of the first audio signal and a signal level of the second audio signal, a comparison of a signal to noise ratio of the first audio signal and a signal to noise ratio of the second audio signal, or a combination thereof
Clause 42. The non-transitory computer-readable medium of any of clauses 27 to 41, wherein the computer-executable instructions that, when executed by the audio system, cause the audio system to deactivate the first or second audio device comprise computer-executable instructions that, when executed by the audio system, cause the audio system to: disable the voice processing algorithm from being performed by the first or second audio device; disable transmission of the second audio signal from the first or second audio device; reduce a power consumption of the first or second audio device; or a combination thereof
Clause 43. The non-transitory computer-readable medium of any of clauses 27 to 42, wherein the computer-executable instructions that, when executed by the audio system, cause the audio system to perform the voice processing algorithm comprise computer-executable instructions that, when executed by the audio system, cause the audio system to perform a voice activity detection (VAD) algorithm, a voice enhancement algorithm, or a combination thereof
Clause 44. The non-transitory computer-readable medium of any of clauses 27 to 43, wherein the computer-executable instructions that, when executed by the audio system, cause the audio system to detect that the quality of the first audio signal does not satisfy the quality threshold comprise computer-executable instructions that, when executed by the audio system, cause the audio system to: detect that an audio signal level of the first audio signal does not satisfy an audio signal level threshold; detect that an audio signal to noise ratio (SNR) of the first audio signal does not satisfy an audio SNR threshold; detect that a microphone quality parameter provided by the first audio device does not satisfy a microphone quality parameter threshold; detect that a wind noise on the first audio signal exceeds a maximum wind noise threshold; detect that a radio frequency (RF) signal level of the first audio signal does not satisfy a RF signal level threshold; detect that an RF SNR of the first audio signal does not satisfy an RF SNR threshold; or a combination thereof
Clause 45. The non-transitory computer-readable medium of any of clauses 27 to 44, wherein the computer-executable instructions that, when executed by the audio system, cause the audio system to measure the quality of the second audio signal comprise computer-executable instructions that, when executed by the audio system, cause the audio system to measure: an audio signal level of the second audio signal; an audio signal to noise ratio (SNR) of the second audio signal; a wind noise on the second audio signal; a radio frequency (RF) signal level of the second audio signal; an RF SNR of the second audio signal; or a combination thereof.
Clause 46. The non-transitory computer-readable medium of any of clauses 32 to 45, wherein the second audio device further comprises a bone conduction microphone (BCM) and wherein an audio signal from the BCM is not considered when measuring the quality of the second audio signal.
Clause 47. The non-transitory computer-readable medium of any of clauses 27 to 46, wherein the first duration of time is selected based on the quality of the second audio signal.
Clause 48. The non-transitory computer-readable medium of any of clauses 27 to 47, wherein the computer-executable instructions that, when executed by the audio system, cause the audio system to, upon determining that the quality of the second audio signal is not better than the quality of the first audio signal deactivate the second audio device for the first duration of time further comprise computer-executable instructions that: after the first duration of time, checking the quality of the first audio signal; upon detecting that the quality of the first audio signal does not satisfy the quality threshold: activating the second audio device; measuring the quality of the second audio signal; upon determining that the quality of the second audio signal is better than the quality of the first audio signal, selecting the second audio device to be the primary audio input device, deactivating the first audio device, and performing the voice processing algorithm on the second audio device; and upon determining that the quality of the second audio signal is not better than the quality of the first audio signal, deactivating the second audio device for the first duration of time.
Clause 49. The non-transitory computer-readable medium of any of clauses 27 to 48, wherein the first audio device is located in a first housing and wherein the second audio device is located in a second housing.
Clause 50. The non-transitory computer-readable medium of any of clauses 36 to 49, wherein the first housing comprises a first earbud and the second housing comprises a second earbud.
Clause 51. The non-transitory computer-readable medium of any of clauses 27 to 50, wherein the first audio device is located in a first housing and wherein the second audio device is located in the first housing.
Clause 52. The non-transitory computer-readable medium of any of clauses 38 to 51, wherein the first housing comprises a head-mounted device.
Clause 53. An apparatus comprising a memory, a transceiver, and a processor communicatively coupled to the memory and the transceiver, the memory, the transceiver, and the processor configured to perform a method according to any of clauses 1 to 13.
Clause 54. An apparatus comprising means for performing a method according to any of clauses 1 to 13.
Clause 55. A non-transitory computer-readable medium storing computer-executable instructions, the computer-executable comprising at least one instruction for causing a computer or processor to perform a method according to any of clauses 1 to 13.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of audio processing handover between audio devices, the method comprising:
selecting a first audio device to be a primary audio input device based on a comparison of a quality of a first audio signal from a microphone of the first audio device and a quality of a second audio signal from a microphone of a second audio device;
deactivating the second audio device;
performing a voice processing algorithm on the first audio device;
detecting that the quality of the first audio signal does not satisfy a quality threshold, and in response:
activating the second audio device;
measuring the quality of the second audio signal;
upon determining that the quality of the second audio signal is better than the quality of the first audio signal, selecting the second audio device to be the primary audio input device, deactivating the first audio device, and performing the voice processing algorithm on the second audio device; and
upon determining that the quality of the second audio signal is not better than the quality of the first audio signal, deactivating the second audio device for a first duration of time.

2. The method of claim 1, wherein selecting the first audio device to be the primary audio input device based on the comparison of the quality of the first audio signal and the quality of the second audio signal comprises selecting the first audio device based on a comparison of a signal level of the first audio signal and a signal level of the second audio signal, a comparison of a signal to noise ratio of the first audio signal and a signal to noise ratio of the second audio signal, or a combination thereof.

3. The method of claim 1, wherein deactivating the first or second audio device comprises:
disabling the voice processing algorithm from being performed by the first or second audio device;
disabling transmission of the second audio signal from the first or second audio device;
reducing a power consumption of the first or second audio device; or
a combination thereof.

4. The method of claim 1, wherein performing the voice processing algorithm comprises performing a voice activity detection (VAD) algorithm, a voice enhancement algorithm, or a combination thereof.

5. The method of claim 1, wherein detecting that the quality of the first audio signal does not satisfy the quality threshold comprises:
detecting that an audio signal level of the first audio signal does not satisfy an audio signal level threshold;
detecting that an audio signal to noise ratio (SNR) of the first audio signal does not satisfy an audio SNR threshold;
detecting that a microphone quality parameter provided by the first audio device does not satisfy a microphone quality parameter threshold;
detecting that a wind noise on the first audio signal exceeds a maximum wind noise threshold;
detecting that a radio frequency (RF) signal level of the first audio signal does not satisfy a RF signal level threshold;
detecting that an RF SNR of the first audio signal does not satisfy an RF SNR threshold; or
a combination thereof.

6. The method of claim 1, wherein measuring the quality of the second audio signal comprises measuring:
an audio signal level of the second audio signal;
an audio signal to noise ratio (SNR) of the second audio signal;
a wind noise on the second audio signal;
a radio frequency (RF) signal level of the second audio signal;
an RF SNR of the second audio signal; or
a combination thereof.

7. The method of claim 6, wherein the second audio device further comprises a bone conduction microphone (BCM) and wherein an audio signal from the BCM is not considered when measuring the quality of the second audio signal.

8. The method of claim 1, wherein the first duration of time is selected based on the quality of the second audio signal.

9. The method of claim 1, further comprising, upon determining that the quality of the second audio signal is not better than the quality of the first audio signal and deactivating the second audio device for the first duration of time:
after the first duration of time, checking the quality of the first audio signal;
upon detecting that the quality of the first audio signal does not satisfy the quality threshold:
activating the second audio device;
measuring the quality of the second audio signal;
upon determining that the quality of the second audio signal is better than the quality of the first audio signal, selecting the second audio device to be the primary audio input device, deactivating the first audio device, and performing the voice processing algorithm on the second audio device; and
upon determining that the quality of the second audio signal is not better than the quality of the first audio signal, deactivating the second audio device for the first duration of time.

10. The method of claim 1, wherein the first audio device is located in a first housing and wherein the second audio device is located in a second housing.

11. The method of claim 1, wherein the first audio device is located in a first housing and wherein the second audio device is located in the first housing.

12. The method of claim 11, wherein the first housing comprises a head-mounted device.

13. An audio system, comprising:
a first audio device and a second audio device, each audio device comprising a microphone, a transceiver, a memory, and at least one processor coupled to the memory and the transceiver, the at least one processor configured to:
select the first audio device to be a primary audio input device based on a comparison of a quality of a first audio signal from a microphone of the first audio device and a quality of a second audio signal from a microphone of the second audio device;
deactivate the second audio device;
perform a voice processing algorithm on the first audio device;
detect that the quality of the first audio signal does not satisfy a quality threshold, and in response:
activate the second audio device;
measure the quality of the second audio signal;
upon determining that the quality of the second audio signal is better than the quality of the first audio signal, select the second audio device to be the primary audio input device, deactivate the first audio device, and perform the voice processing algorithm on the second audio device; and
upon determining that the quality of the second audio signal is not better than the quality of the first audio signal, deactivate the second audio device for a first duration of time.

14. The audio system of claim 13, wherein, to select the first audio device to be the primary audio input device based on the comparison of the quality of the first audio signal and the quality of the second audio signal, the at least one processor is configured to select the first audio device based on a comparison of a signal level of the first audio signal and a signal level of the second audio signal, a comparison of a signal to noise ratio of the first audio signal and a signal to noise ratio of the second audio signal, or a combination thereof.

15. The audio system of claim 13, wherein, to deactivate the first or second audio device, the at least one processor is configured to:
disable the voice processing algorithm from being performed by the first or second audio device;
disable transmission of the second audio signal from the first or second audio device;
reduce a power consumption of the first or second audio device; or
a combination thereof.

16. The audio system of claim 13, wherein, to perform the voice processing algorithm, the at least one processor is configured to perform a voice activity detection (VAD) algorithm, a voice enhancement algorithm, or a combination thereof.

17. The audio system of claim 13, wherein, to detect that the quality of the first audio signal does not satisfy the quality threshold, the at least one processor is configured to:
detect that an audio signal level of the first audio signal does not satisfy an audio signal level threshold;
detect that an audio signal to noise ratio (SNR) of the first audio signal does not satisfy an audio SNR threshold;
detect that a microphone quality parameter provided by the first audio device does not satisfy a microphone quality parameter threshold;
detect that a wind noise on the first audio signal exceeds a maximum wind noise threshold;
detect that a radio frequency (RF) signal level of the first audio signal does not satisfy a RF signal level threshold;
detect that an RF SNR of the first audio signal does not satisfy an RF SNR threshold; or
a combination thereof.

18. The audio system of claim 13, wherein, to measure the quality of the second audio signal, the at least one processor is configured to measure:
an audio signal level of the second audio signal;
an audio signal to noise ratio (SNR) of the second audio signal;
a wind noise on the second audio signal;
a radio frequency (RF) signal level of the second audio signal;
an RF SNR of the second audio signal; or
a combination thereof.

19. The audio system of claim 18, wherein the second audio device further comprises a bone conduction microphone (BCM) and wherein an audio signal from the BCM is not considered when measuring the quality of the second audio signal.

20. The audio system of claim 13, wherein the first duration of time is selected based on the quality of the second audio signal.

21. The audio system of claim 13, wherein the at least one processor is further configured to, upon determining that the quality of the second audio signal is not better than the quality of the first audio signal and deactivating the second audio device for the first duration of time:
after the first duration of time, check the quality of the first audio signal;
upon detecting that the quality of the first audio signal does not satisfy the quality threshold:
activate the second audio device;
measure the quality of the second audio signal;
upon determining that the quality of the second audio signal is better than the quality of the first audio signal, select the second audio device to be the primary audio input device, deactivate the first audio device, and perform the voice processing algorithm on the second audio device; and
upon determining that the quality of the second audio signal is not better than the quality of the first audio signal, deactivate the second audio device for the first duration of time.

22. The audio system of claim 13, wherein the first audio device is located in a first housing and wherein the second audio device is located in a second housing.

23. The audio system of claim 13, wherein the first audio device is located in a first housing and wherein the second audio device is located in the first housing.

24. The audio system of claim 23, wherein the first housing comprises a head-mounted device.

25. An audio system, comprising:
means for selecting a first audio device to be a primary audio input device based on a comparison of a quality of a first audio signal from a microphone of the first audio device and a quality of a second audio signal from a microphone of a second audio device;
means for deactivating the second audio device;
means for performing a voice processing algorithm on the first audio device;
means for detecting that the quality of the first audio signal does not satisfy a quality threshold, and in response:
activating the second audio device;
measuring the quality of the second audio signal;
upon determining that the quality of the second audio signal is better than the quality of the first audio signal, selecting the second audio device to be the primary audio input device, deactivating the first audio device, and performing the voice processing algorithm on the second audio device; and
upon determining that the quality of the second audio signal is not better than the quality of the first audio signal, deactivating the second audio device for a first duration of time.

26. The audio system of claim 25, wherein the means for selecting the first audio device to be the primary audio input device based on the comparison of the quality of the first audio signal and the quality of the second audio signal comprises means for selecting the first audio device based on a comparison of a signal level of the first audio signal and a signal level of the second audio signal, a comparison of a signal to noise ratio of the first audio signal and a signal to noise ratio of the second audio signal, or a combination thereof.

27. The audio system of claim 25, wherein the means for deactivating the first or second audio device comprises:
means for disabling the voice processing algorithm from being performed by the first or second audio device;
means for disabling transmission of the second audio signal from the first or second audio device;
means for reducing a power consumption of the first or second audio device; or
a combination thereof.

28. The audio system of claim 25, wherein the means for performing the voice processing algorithm comprises means for performing a voice activity detection (VAD) algorithm, a voice enhancement algorithm, or a combination thereof.

29. The audio system of claim 25, wherein the means for detecting that the quality of the first audio signal does not satisfy the quality threshold comprises:
means for detecting that an audio signal level of the first audio signal does not satisfy an audio signal level threshold;
means for detecting that an audio signal to noise ratio (SNR) of the first audio signal does not satisfy an audio SNR threshold;
means for detecting that a microphone quality parameter provided by the first audio device does not satisfy a microphone quality parameter threshold;
means for detecting that a wind noise on the first audio signal exceeds a maximum wind noise threshold;
means for detecting that a radio frequency (RF) signal level of the first audio signal does not satisfy a RF signal level threshold;
means for detecting that an RF SNR of the first audio signal does not satisfy an RF SNR threshold; or
a combination thereof.

30. The audio system of claim 25, wherein the means for measuring the quality of the second audio signal comprises means for measuring:
an audio signal level of the second audio signal;
an audio signal to noise ratio (SNR) of the second audio signal;
a wind noise on the second audio signal;
a radio frequency (RF) signal level of the second audio signal;
an RF SNR of the second audio signal; or
a combination thereof.

31. The audio system of claim 25, wherein the first audio device is located in a first housing and wherein the second audio device is located in the first housing.

32. The audio system of claim 31, wherein the first housing comprises a head-mounted device.

33. A non-transitory computer-readable medium storing computer-executable instructions that, when executed by an audio system, cause the audio system to:
select a first audio device to be a primary audio input device based on a comparison of a quality of a first audio signal from a microphone of the first audio device and a quality of a second audio signal from a microphone of a second audio device;
deactivate the second audio device;
perform a voice processing algorithm on the first audio device;
detect that the quality of the first audio signal does not satisfy a quality threshold, and in response:
activating the second audio device;
measuring the quality of the second audio signal;
upon determining that the quality of the second audio signal is better than the quality of the first audio signal, selecting the second audio device to be the primary audio input device, deactivating the first audio device, and performing the voice processing algorithm on the second audio device; and
upon determining that the quality of the second audio signal is not better than the quality of the first audio signal, deactivating the second audio device for a first duration of time.
